(19) United States
(12) Patent Application Publication
(10) Pub. No.: US 2012/0315932 A1
(43) Pub. Date: Dec. 13, 2012

(54) MESSAGING SYSTEM AND METHOD

(76) Inventors: David Edward Spann, Bristol (GB); Michael Radford, Oxon (GB); Jasmeet Singh Gulati, Bristol (GB)

(21) Appl. No.: 13/580,464

(22) PCT Filed: Mar. 23, 2011
(86) PCT No.: PCT/IE2011/000018

§ 371 Date: Aug. 22, 2012

Related U.S. Application Data
(60) Provisional application No. 61/282,744, filed on Mar. 25, 2010.

(51) Int. Cl. H04W 4/14

(52) U.S. Cl. 455/466

(57) ABSTRACT

A system of the invention processes messages to and from application servers. The system monitors parameters such as number of incoming messages to a particular service and from a particular subscriber. Based on this parameter and possibly also on analysis of content in a message an action is automatically triggered. The system may allow a user to generate a limit as to the number of messages they are willing to receive before they sign up for a service. This is performed by either pre-configuring the system with default limits or allowing the user to add additional text to a subscription message to state the limit they wish to set. Once the user signs up for a service the system generates a counter to track how many messages the service provider sends to the user and once this counter reaches 0 the service provider is sent an automated STOP request.

The invention relates to processing of messages that are transmitted by automated services.

Automated services are hosted by application servers in a network, which are capable of sending many thousands of messages per minute and for any individual subscriber an excessive number may be received in a short time. A user typically has to subscribe to an automated service and is usually made aware of how much each messsage will cost but not the rate at which the messages come in. Therefore users might not subscribe to a service as they do not trust that the automated service will act in a fair way and flood them with messages and hence cost.

US2005/0020289 (Kim et al) describes a method for blocking spam messages in a mobile communication terminal, based on “blacklisting” particular numbers. WO2007/049285 (Somasundaram) also describes white/black listing.

An object of the invention is to achieve greater automation, and/or greater versatility in processing of messages from automated services. Another object is to allow users to have greater flexibility in signing up for automated services with the ability to control that subscription.

### SUMMARY OF THE INVENTION

According to the invention, there is provided a message processing system comprising:
an interface adapted to receive messages originating in an application server, and addressed to a user device; and
a processor adapted to parse messages and to decide on an automatic trigger action according to said parsing and one or more parameters,
wherein the system comprises a configuration function allowing subscribers to modify said parameters, and
wherein a parameter is a threshold number of messages for a subscriber from a particular service or for a time period, the processor is adapted to determine if the threshold is reached, and the trigger action is stopping further messages from that service.

In one embodiment, the processor has an interface for routing received messages for delivery to the subscriber.

In one embodiment, the system is adapted to communicate with a message service centre such as an SMSC.

In one embodiment, the processor triggers the action according to pre-configured rules.

In one embodiment, the processor is adapted to determine a parameter value from a subscriber-originated message.

In another embodiment, the processor is adapted to transmit a stop command message to an application server, said message emulating such a message which would be sent by a subscriber.

In one embodiment, a parameter is an identifier for a subscriber group of which the addressee is a member and which the threshold applies to.

In one embodiment, the value is number of messages per member of a group, related to a total number of messages for the group. In one embodiment, the system is adapted to communicate with an IP messaging system to implement a trigger action such as an application server or Call Session Control Function as defined in 3GPP IMS.

In one embodiment, the processor is adapted to decrement or increment a counter to determine if the threshold is reached.

According to another aspect, the invention provides a message processing method implemented by a system comprising an interface to receive messages originating in an application server, and addressed to a user device; and a processor;
the method comprising the steps of:
   in a configuration step the processor allowing subscribers to modify parameters, wherein a parameter is a threshold number of messages for a subscriber from a particular service or for a time period,
   the processor parsing a message and deciding, according to said parsing and one or more of said parameters, on an automatic trigger action including stopping of further messages for a service, and
   wherein the processor decrements a counter to determine if the threshold is reached.

In one embodiment, the system routes received messages to the subscriber.

In one embodiment, the system communicates with a message service centre such as an SMSC.

In a further embodiment, the processor triggers the action according to pre-configured rules.

In one embodiment, the processor determines a parameter value from a subscriber-originated message.

In one embodiment, the processor transmits a stop command message to an application server, said message emulating such a message which would be sent by a subscriber.

In one embodiment, a parameter is an identifier for a subscriber group of which the addressee is a member and which the threshold applies to. In one embodiment, the value is number of messages per member of a group, related to a total number of messages for the group.

In one embodiment, the system communicates with an IP messaging system to implement a trigger action such as an application server or Call Session Control Function as defined in 3GPP IMS.

In one embodiment, the processor decrements or increment a counter to determine if the threshold is reached.

In a further aspect, the invention provides a computer program product comprising a computer usable medium having a computer readable program code embodied therein, said computer readable program code adapted to be executed to implement a message processing method when executing on a digital processor, said method comprising the steps of:
in a configuration step allowing subscribers to modify parameters, wherein a parameter is a threshold number of messages for a subscriber from a particular service or for a time period,
parsing a message and deciding, according to said parsing and one or more of said parameters, on an automatic trigger action including stopping of further messages for a service, and
wherein the processor decrements a counter to determine if the threshold is reached.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a flow diagram illustrating a message transfer sequence of the invention and how it stops an automated service when the user's limit has been reached;

FIG. 2 is a flow diagram for a message sequence in this case triggered by a user and shows how the user is able to set the limit when they subscribe to the automated service; and

FIG. 3 is an event trace diagram showing the possible problem without the invention where the user is exposed to overcharging and unwanted messages, and FIG. 4 is an event trace diagram showing a system of the invention automatically preventing a user from being overcharged and receiving unwanted messages.

### DESCRIPTION OF THE EMBODIMENTS

Glossary of Terms and their Definitions:

SMS—Short Message Service

Prepaid subscriber—A mobile phone user who provides credit to the operator to pay for the use of their services in advance.

Postpaid subscriber—A mobile phone user who is billed in arrears for the services that they consume within an operator.

IVR—Interactive Voice Response

USSD—Unstructured Supplementary Service Data

SME—Short Message Entity

IMS—IP Multimedia Subsystem

CSCF—Call Session Control Function

AS—Application Server

SIP—Session Initiation Protocol

SMPP—Short Message Peer-to-Peer protocol

UCP—Universal Computer Protocol

CIMD—Computer Interface Message Distribution

RTPP—Real Time Prepaid Protocol

A system of the invention processes messages to and from application servers. The system monitors parameters such as number of incoming messages to a particular service and from a particular subscriber. Based on this parameter and possibly also on analysis of content in a message an action is automatically triggered.

The system 1 is based on software running on a hardware platform in one embodiment of a multi-core processor like the Intel x86 64 bit™. The system has memory to allow the storage of the software whilst it is running as well as providing a location for the running software to store and retrieve counters that are described below. To provide persistence of the counters in case of failure or unexpected termination of the software or hardware platform a disk is used to allow the storage of the counters. This may include the use of a database like Oracle™ or IBM Informix™ to store these counters or a simpler file structure like plain flat files within a directory structure. The running of the software on the hardware is under the control of an operating system and this is in one embodiment the Redhat Linux™ family of products like Enterprise Linux™.

The system has multiple types of interfaces to charging and billing systems, in one embodiment based on IP technology or SS7 (INAP/CAMEL) depending on the architecture of the charging/billing system. For interfacing to the application server be it an SMSC, MMSC or CSCF there are various interfaces, in some embodiments based on IP, that the system 1 uses.

For SMS the high level interface that runs over IP is SMPP, UCP or CIMD, and for MMS it is typically RTPP and for CSCFs it is Diameter Ro/Rf.

In one embodiment the system allows a user to generate a limit as to the number of messages they are willing to receive before they sign up for a service. This is performed by either pre-configuring the system with default limits or allowing the user to add additional text to a subscription message to state the limit they wish to set. Once the user signs up for a service, the system generates a counter to track how many messages the service provider sends to the user and once this counter reaches 0 the service provider is sent an automated STOP request.

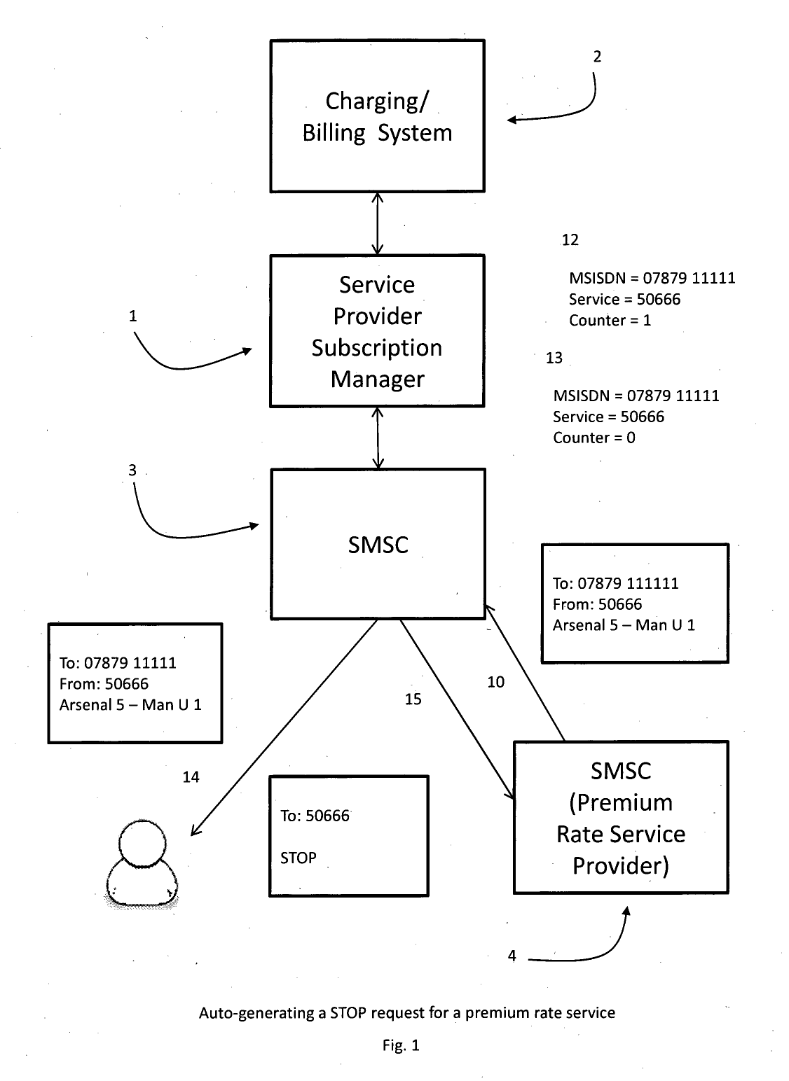

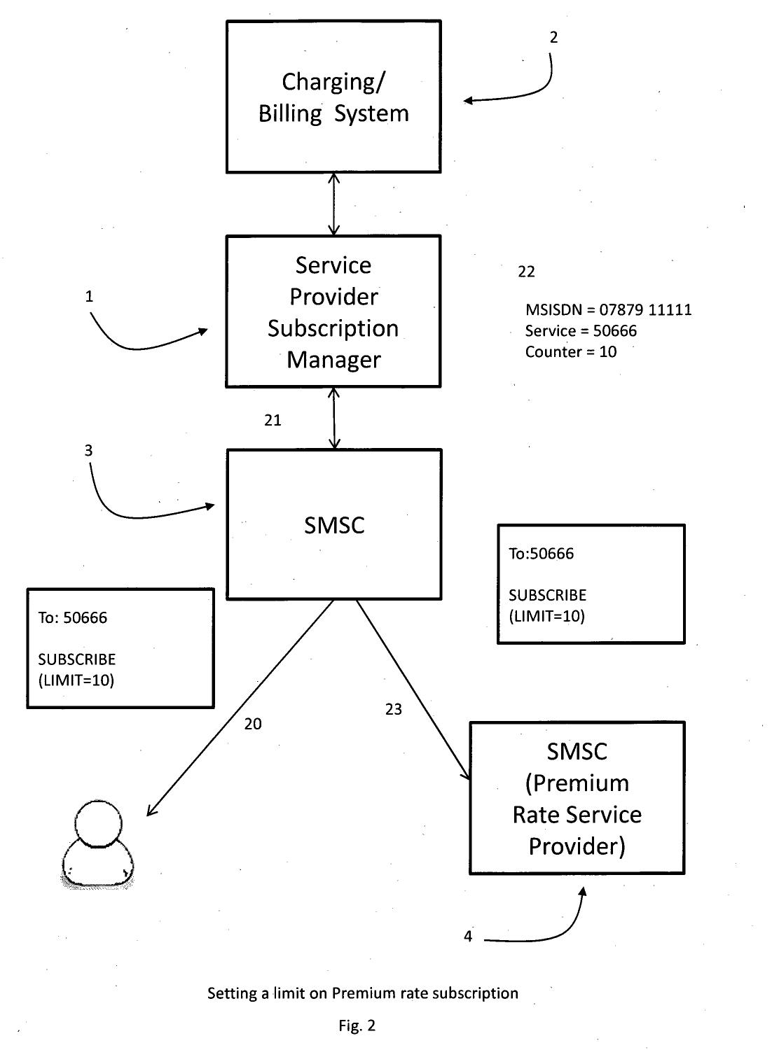

A service provider subscription manager 1 is shown in FIGS. 1 and 2 and FIG. 1 shows how the limit that has been set is used to automatically stop a service once the required number of messages has been received. The service provider subscription manager system 1 is a server interfacing with a billing system 2 and with an SMSC 3. The SMSC 3 in turn interfaces with a short message entity (SME) Premium Rate Service Provider 4.

The system 1 allows a user to specify a limit of messages that they are willing to receive from the premium rate service before the service is automatically cut off on their behalf. In the example of FIG. 1 the following is the sequence of steps:

10, message from the premium rate service server 4 to the SMSC 3,

11, SMSC to system 1;

12, in communication with the billing system 2 the system 1 determines a counter value associated with the MSISDN and Service identifier,

13, the counter value is decremented,

14, the SMSC passes on the service message to the user device,

15, the system 1 sends a STOP message to the server 4 as the counter value has reached zero.

In the example of FIG. 2 the user signs up for 10 messages from the premium rate service by adding additional data in a text message ([LIMIT=10]) that is used by the system 1 to create a counter that will be decremented each time the service provider server 4 sends a message.

Here the user device sends 20 a command specifying the limit, and this is forwarded (21) to the service provider subscription manager system 1. The system 1 dynamically creates (22) a counter that tracks an association of the user, the service subscribed to, and the limit that the user wishes to impose. The limit text message is forwarded in step 23 to the SME 4, which makes use of the information to constrain the service or chooses to ignore it. Likewise, the extra text could be removed by the SMSC 3 so that the service provider server 4 receives the original text it was expecting.

Now, when the service provider server 4 sends messages to the subscriber the system 1 is interrogated and it decrements the counter for each message being sent to the subscriber. When only 1 more message is allowed to be sent the message is allowed, however an automated STOP command is generated as shown in FIG. 1.

When the counter is 0 if the service provider server 4 tries to send any new content because they either did not receive the STOP command, it was in the process of sending new content before the STOP command arrived, or it ignored the command then the system 1 would deny the message from being delivered and charged to the subscriber.

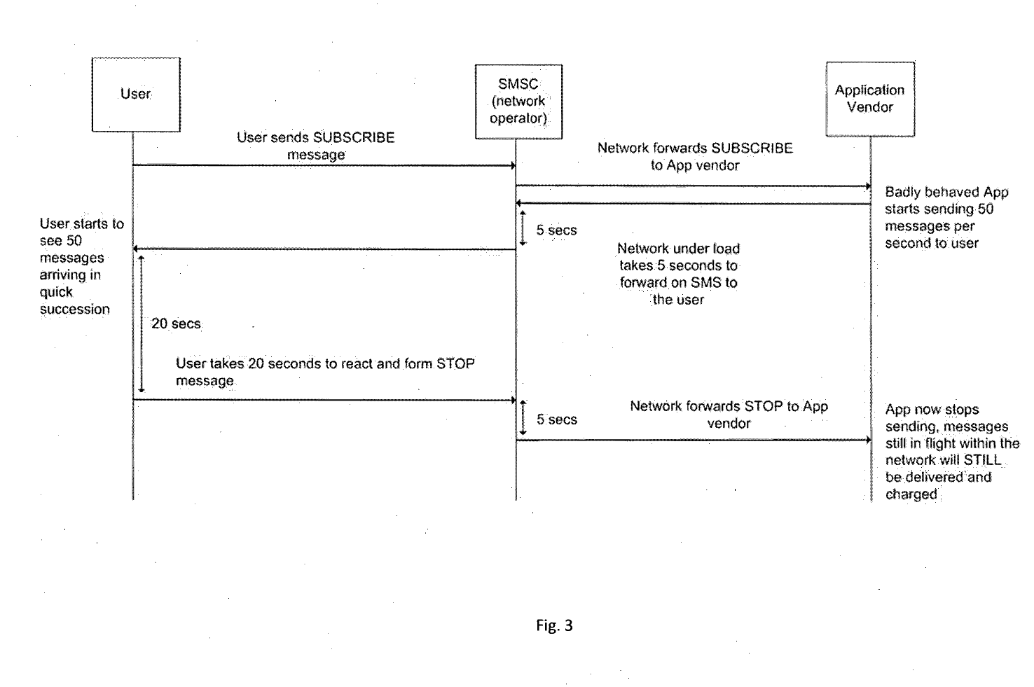

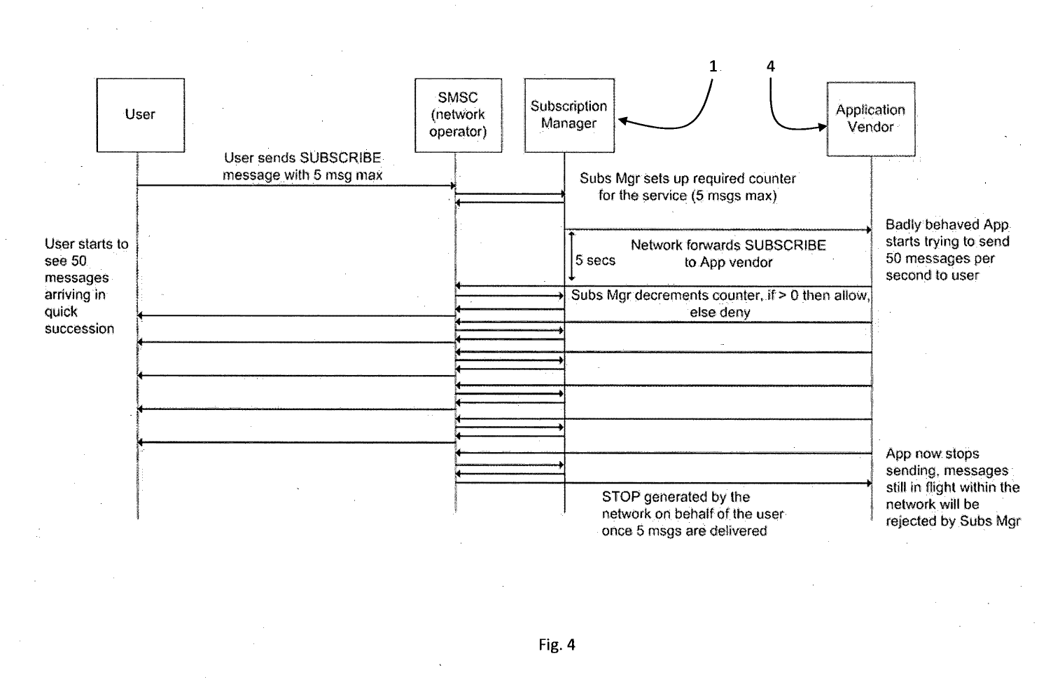

Referring to FIG. 3 it is evident that the human user takes an amount of time to detect that the application is sending too many messages for their need, they have to open their phone, detect which application is causing the issue and then having to form the correct STOP message to return to the correct short code service. FIG. 3 shows how easily the user could be charged up to £375 and have received 1500 unwanted messages. In the example of FIG. 3 the application vendor has been able to send 50 messages per second for 30 seconds (5+20+5) until the user's STOP command, initiated by writing an SMS message, arrives at the application vendor server.

Referring to FIG. 4 the system of the invention intercepts the delivery attempt of every message and by use of the system 1 the user has signed up to only receiving five messages from this application provider. So, even if the application server attempts to send messages only five will be charged and delivered to the user, and all others will be rejected. Also, due to the subscription manager system 1 being able to run on hardware and at processor speeds of processing thousands of messages per second the STOP message is likely to have been generated within the second of being received at the SMSC 3, which is not possible for the human user who reacts slower but also has the air interface between the SMSC and themselves, which can also introduce delays in receiving the messages. In the example of FIG. 4 the application vendor has been able to attempt to send 50 messages per second until the network issues the STOP command. The STOP command is sent automatically and after the required number of messages has been sent to the ,user. Even if other messages are in flight within the network they are not charged or delivered to the user.

With reference again to FIG. 2, where the user has selected a limit of 10 if the service provider on receiving the initial subscription tries to send say 100 messages in quick succession only 10 will successfully be sent and 90 of them will be rejected by the system 1. In this way the user is able to pre-allocate a limit of messages and be comfortable in signing up to the service as they know the maximum cost to them if the service is not well behaved and tries to “flood” the user.

The invention also allows the user to specify the period for which the limit should be applied, so for example LIMIT=10, PERIOD=1 w would allow 10 SMS messages to be sent per week. LIMIT=10, PERIOD=1 m would allow 10 SMS messages to be sent per month. The PERIOD keyword is used to determine the interval at which the system should reset the counter to the LIMIT value.

The invention allows the user to be notified if the limit is close to being reached (i.e at a predefined threshold) allowing them to reauthorise if they wish and increase the limit. This enables them to increase the counter before the STOP message is sent, and having to resubscribe to the service.

The invention could alternatively involve processing in mechanisms other than SMS to allow the limits to either be set or extended. These include IVR, USSD, Web (XML, HTML, Javascript, or SIP) or MMS interfaces where the user could interogate the current value of the counters for each service and even request to increase or remove them. So, for example if the user signs up to a service and sets an initial limit of 10 but then only receives 1 SMS per week they may feel comfortable and have built up trust with that service provider to extend before the 10^{th} week to increase to 50. They may even elect to remove the limitation and have an infinite counter that they could always reinstate if the service starts to send more frequent messages.

The invention also allows for the limits on the number of messages that a user wishes to receive to be pre-configured. So for example using either SMS, or USSD, or IVR, or Web, or MMS, or SIP the user could state that for all premium rate services they want a limitation of 20 SMS messages. Then, when they subscribe to a new service they would not need to add the additional [LIMIT=] text as the invention would automatically allocate 20 as the limit.

The invention is not limited to SMS and could equally interface to an MMSC or email server or GPRS subsystems to allow for MMS or emails to be likewise limited. The evolution of IP networks within an operator have added to the GPRS subsystems with additional servers and services called the IP Multimedia Subsystem (IMS). Within an IMS network there are application servers (AS) and devices called Call Session Control Function (CSCF) which control the routing of IP messages between phones. This invention is equally applicable to IMS networks where either an AS or CSCF can interact with the system of the invention and likewise limit Pager Mode, Large Mode or session mode messages as defined in the IP world.

The invention also allows a mechanism for the subscriber of the service to not only make use of counters assigned to themselves but also to use counters that are part of another user's account. For example, a father may own the counters and a child signs up to the service using the father's account as where the counter and money is deducted from. The counter or money can also be shared amongst a group of people so a family or small business could share a counter that is used to control the number of messages that can be delivered to all of them. For example, a subscription for 10 messages limits the application to only be able to send 10 messages in total to the family. The messages could be allocated to a specific sub-set per person in the group. The owner of the account will take part in authorising who is able to subscribe to a service using the shared counter, either by assigning MSISDNs/IMSIs that are authorised or by being part of the subscribed flow in agreeing that the subscription can occur.

In another embodiment of the invention the functionality is within the charging system itself using the account infrastructure that is currently used to determine how much money the subscriber has or owes to the operator. Alternatively, the limit could be in terms of maximum amount of credit exposure that the user wants to incur, so for example on signing up for the service they could state that a limit of £5 for the service is put in place and hence if the service costs £2.50 per message then only 2 messages would be received, if 50 p per message then 10 messages would be allowed.

In another embodiment of the invention, the SMSC has this functionality with the software program running within the SMSC and creating counters that reside within the SMSC.

In another embodiment, instead of residing between an SMSC and a charging/billing system the system is a (service centre (for example, SMSC or MMSC) adjunct that intercepts the messages going in and out of the service centre.

The invention is not limited to the embodiments described but may be varied in construction and detail. For example, the invention could be implemented for other types of messages such as MMS or email. Also, it could be invoked by an MMSC or email server instead of or in addition to an SMSC. Also, functionality to implement the invention could reside separately, or it could be a feature running inside an SMSC or it could be within a charging/billing system. Also, where in this specification there is a reference to decrementing a counter this is not necessarily literally how the processor operates. For example it could alternatively increment a counter and determine if a threshold is reached.

1. A message processing system comprising:
an interface adapted to receive messages originating in an application server, and addressed to a user device; and
a processor adapted to parse messages and to decide on an automatic trigger action according to said parsing and one or more parameters,
wherein the system comprises a configuration function allowing subscribers to modify said parameters, and
wherein a parameter is a threshold number of messages for a subscriber from a particular service or for a time period, the processor is adapted to determine if the threshold is reached, and the trigger action is stopping further messages from that service.

2. A message processing system as claimed in claim 1, wherein the processor has an interface for routing received messages for delivery to the subscriber.

3. A message processing system as claimed in claim 1, wherein the system is adapted to communicate with a message service centre such as an SMSC.

4. The message processing system as claimed in claim 1, wherein the processor triggers the action according to pre-configured rules.

5. The message processing system as claimed in claim 1, wherein the processor is adapted to determine a parameter value from a subscriber-originated message.

6. The message processing system as claimed in claim 1, wherein the processor is adapted to transmit a stop command message to an application server, said message emulating such a message which would be sent by a subscriber.

7. The message processing system as claimed in claim 1, wherein a parameter is an identifier for a subscriber group of which the addressee is a member and which the threshold applies to.

8. The message processing system as claimed in claim 1, wherein a parameter is an identifier for a subscriber group of which the addressee is a member and which the threshold applies to; and wherein the value is number of messages per member of a group, related to a total number of messages for the group.

9. The message processing system as claimed in claim 1, where the system is adapted to communicate with an IP messaging system to implement a trigger action such as an application server or Call Session Control Function as defined in 3GPP IMS.

10. The message processing system as claimed in claim 1, wherein the processor is adapted to decrement or increment a counter to determine if the threshold is reached.

11. A message processing method implemented by a system comprising an interface to receive messages originating in an application server, and addressed to a user device; and a processor;
the method comprising the steps of:
in a configuration step the processor allowing subscribers to modify parameters, wherein a parameter is a threshold number of messages for a subscriber from a particular service or for a time period,
the processor parsing a message and deciding, according to said parsing and one or more of said parameters, on an automatic trigger action including stopping of further messages for a service, and
wherein the processor decrements a counter to determine if the threshold is reached.

12. The method as claimed in claim 11, wherein the system routes received messages to the subscriber.

13. The method as claimed in claim 11, wherein the system communicates with a message service centre such as an SMSC.

14. The method as claimed in claim 11, wherein the processor triggers the action according to pre-configured rules.

15. The method as claimed in claim 11, wherein the processor determines a parameter value from a subscriber-originated message.

16. The method as claimed in claim 11, wherein the processor transmits a stop command message to an application server, said message emulating such a message which would be sent by a subscriber.

17. The method as claimed in claim 11, wherein a parameter is an identifier for a subscriber group of which the addressee is a member and which the threshold applies to.

18. The method as claimed in claim 11, wherein a parameter is an identifier for a subscriber group of which the addressee is a member and which the threshold applies to; and wherein the value is number of messages per member of a group, related to a total number of messages for the group.

19. The method as claimed in claim 11, where the system communicates with an IP messaging system to implement a trigger action such as an application server or Call Session Control Function as defined in 3GPP IMS.

20. The method as claimed in claim, 11 wherein the processor decrements or increments a counter to determine if the threshold is reached.

21. A computer program product comprising a computer usable medium having a computer readable program code embodied therein, said computer readable program code adapted to be executed to implement a message processing method when executing on a digital processor, said method comprising the steps of:
in a configuration step allowing subscribers to modify parameters, wherein a parameter is a threshold number of messages for a subscriber from a particular service or for a time period,
parsing a message and deciding, according to said parsing and one or more of said parameters, on an automatic trigger action including stopping of further messages for a service, and
wherein the processor decrements a counter to determine if the threshold is reached.
